(19) United States
(12) Patent Application Publication
(10) Pub. No.: US 2023/0401499 A1
(43) Pub. Date: Dec. 14, 2023

(54) INCREASING DATA DIVERSITY TO ENHANCE ARTIFICIAL INTELLIGENCE DECISIONS

(71) Applicant: International Business Machines Corporation, Armonk, NY (US)

(72) Inventors: Michael Boone, Lutz, FL (US); Jeremy R. Fox, Georgetown, TX (US); Tushar Agrawal, West Fargo, ND (US); Sarbajit K. Rakshit, Kolkata (IN)

(21) Appl. No.: 17/806,307

(22) Filed: Jun. 10, 2022

(51) Int. Cl. G06Q 10/06

(52) U.S. Cl. CPC G06Q 10/063116; G06Q 10/06398

(57) ABSTRACT

Provided is a computer-implemented method, system, and computer program product for increasing data diversity to enhance artificial intelligence decisions. A processor may generate a corpus of data for a facility, the corpus of data having activities performed by workers at the facility. The processor may select an activity to be completed. The processor may generate, based on the corpus, a first plan for completing the activity, the first plan having a set of tasks for completing the activity and a set of workers to perform the tasks. The processor may collect performance data that is generated when completing the activity using the first plan. The processor may update the corpus of data with the performance data. The processor may analyze the updated corpus of data to identify an aspect for improving efficiency of the first plan. The processor may recommend, based on the analyzing, modification of the first plan.

### BACKGROUND

The present disclosure relates generally to the field of artificial intelligence and, more specifically, to increasing data diversity to enhance artificial intelligence decisions.

In many industries, human and robotic workers may be used to perform various activities. For example, in the automotive industry, human and robotic workers may be used to complete various tasks on an assembly line for manufacturing an automobile. In many instances, the human and robotic workers are assigned to perform tasks based on their given capabilities, costs, health conditions, etc., associated with completing the various tasks related to the given activity.

### SUMMARY

Embodiments of the present disclosure include a computer-implemented method, system, and computer program product for increasing data diversity to enhance artificial intelligence decisions. A processor may generate, for a digital twin of a facility, a corpus of data, wherein the corpus of data comprises a plurality of activities performed by a plurality of workers at the facility. The processor may select an activity to be completed at the facility. The processor may generate, by an activity assignment model and based on the corpus of data, a first plan for completing the activity, the first plan comprising a first set of tasks for completing the activity and a first set of workers to perform the first set of tasks. The processor may collect a first set of performance data that is generated when completing the activity using the first plan. The processor may update the corpus of data with the first set of performance data. The processor may analyze, by an automation model, the updated corpus of data to identify an aspect for improving efficiency of the first plan. The processor may recommend, by the automation model and based on the analyzing, modification of the first plan.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example intelligent assignment system, in accordance with some embodiments of the present disclosure.

FIG. 2 illustrates an example diagram for intelligent assignment of activities, in accordance with some embodiments of the present disclosure.

FIG. 3 illustrates an example process for intelligent assignment of workers using predictive learning, in accordance with some embodiments of the present disclosure.

FIG. 4 illustrates a subprocess of the example process of FIG. 3 for intelligent assignment of workers using predictive learning, in accordance with some embodiments of the present disclosure.

FIG. 5 illustrates an example process for intelligent assignment of activities based on various attributes, in accordance with some embodiments of the present disclosure.

FIG. 6 illustrates a high-level block diagram of an example computer system that may be used in implementing one or more of the methods, tools, and modules, and any related functions, described herein, in accordance with embodiments of the present disclosure.

FIG. 7 depicts a cloud computing environment in accordance with embodiments of the present disclosure.

FIG. 8 depicts abstraction model layers in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to the field of artificial intelligence and, more particularly, to increasing data diversity to enhance artificial intelligence decisions. While the present disclosure is not necessarily limited to such applications, various aspects of the disclosure may be appreciated through a discussion of various examples using this context.

Artificial intelligence (AI) is a field of computer science that allows a computer system to mimic human intelligence. AI systems do not require pre-programming; instead, they use algorithms which can work with their own intelligence. AI systems involve machine learning algorithms or models such as reinforcement learning algorithms and deep learning neural networks. Machine learning enables a computer system to make predictions or decisions using historical data without being explicitly programmed. Machine learning uses a massive amount of structured and semi-structured data so that a machine learning model can generate accurate results or give predictions based on that data. AI systems may utilize machine learning models to process large quantities of data very quickly using algorithms that change over time in order to improve various processes. For example, a manufacturing plant might collect data from robotic systems/machines and sensors on its network in quantities far beyond what any human is capable of processing. The AI system may use machine learning to spot patterns and identify anomalies, which may indicate a problem that can be addressed.

AI systems learn based on historical interaction with a given system. For example, when trying to understand how activities are performed on an industrial floor by various workers (human and robotic workers), the AI system will gather data details showing how the activity is performed, various commands required for performing the activity, and consider surrounding contextual data so that the system can learn. Using the collected data, the AI system can make determinations based on how human workers will perform a given activity differently from one another, and at the same time, how robotic workers will perform the activity differently from the human workers. Once the AI system gathers sufficient information about any activity, a knowledge corpus can be created. To nurture an AI system to maturity, the AI system should learn how the same activity can be performed in a different manner(s) during the learning phase, and at the same time, how human(s) can perform differently from robotic workers/system, and how different skills of the respective worker can perform the same activity, in different ways, etc. However, problems arise when data diversity is limited. For example, if the same activity is performed by the same sets of workers, then the AI system will not be able to learn if there is a better way to perform the activity.

Embodiments of the present disclosure include a system, computer-implemented method, and computer program product that are configured to assign different activities to be performed by to human and/or robotic workers in an intelligent manner to capture significant data from different human and/or robotic workers combinations. Using performance data from assigning workers to complete various activities, the system may learn a better approach for assigning activities based on context, skills, environment etc. In this way, the system can generate enough data for creating a large and diverse knowledge corpus within controlled electrical engineering constructs (e.g., control systems, robotics, computer engineering, etc.).

In embodiments, the system may generate, for a digital twin of a facility, a corpus of data, wherein the corpus of data comprises a plurality of activities performed by a plurality of workers at the facility. In embodiments, the plurality of workers may include human workers, robotic workers/systems, and/or a combination of human and robotic workers.

In embodiments, the corpus of data may be generated from various data collected from the facility. For example, the system may collect human worker data, robotic worker data, activity data, and/or tasks performed at the facility from facility computer systems. For example, the system may capture data generated from Internet of Things (IoT) devices, robotic systems, networks, sensors, log etc., associated with the facility and use those gathered data through machine learning to create knowledge corpus.

In embodiments, the corpus of data may include additional attributes associated with the facility, the activities, and the workers. For example, the attributes may include tasks associated with completing each activity, specialist categories associated with each workers, worker capabilities, human and robotic worker health, activity types, activity volume, facility demographics, activity costs, and laws associated with human workers performing activities at the facility.

In embodiments, the system may select an activity or activities to be completed at the facility. Once the activity is selected, the system will generate, using an activity assignment model and based on the corpus of data, a first plan for completing the activity. In embodiments, the first plan may comprise a first set of tasks for completing the activity and a first set of workers to perform the first set of tasks. For example, the activity assignment model will identify each activity to be performed at the facility and the workers available for completing the activity. The activity may include multiple tasks that may be performed by different workers in order to complete the activity. The activity assignment model may assign workers to perform the activity based on their various attributes (skills, capabilities, health, etc.). In embodiments, the activity assignment model will also consider the contextual situation, working environment, criticality of the activities etc., when assigning the activities for completion. For example, if human workers can only work 8 hours a shift, and robotic workers can work continuously, the activity assignment model will take this into account when assigning workers to activities.

In embodiments, the activity assignment model may select only human workers, only robotic workers, or a combination of human worker and robotic worker to perform the plan for completing the given activity. Varying the selection of the type of workers for performing the activity allows the system to create a diverse data set for activities performed at the facility. For example, different human workers can have different types of skills, different skill levels, and/or a different way of performing the activities. Similarly, different robotic workers can have different types of capabilities and/or health conditions (e.g., older robotic system, newer robotic system, wear and tear, etc.). Varying the selection of workers for completing the activity allows the system to learn which is the best manner for assigning workers to complete activities at the facility over time.

In embodiments, the system may collect a first set of performance data that is generated when completing the activity using the first plan. For example, the workers will be performing the activities and generating data that is collected from various IoT devices, scanning, data logs, sensors, networks, etc., maintained at the facility.

In embodiments, the system will update the corpus of data with the first set of performance data. The system will then analyze, using an automation/optimization model, the updated corpus of data to identify an aspect for improving efficiency of the first plan. For example, the automation model may identify that a given worker (human or robotic) may perform a task of the first plan better or more efficiently than another worker. In another example, the system may identify that one robotic worker may perform an activity or task better than two or more human workers.

In embodiments, the system will recommend, using the automation model and based on the analyzing, modification of the first plan. The recommended modification of the first plan may include changing the first plan to include at least one alternative task and/or at least one alternative worker (human, robotic, or combination).

In embodiments, the system may generate, using the activity assignment model and based on the recommendation from the automation model, a second plan for completing the activity. For example, the second plan may include one or more alternative workers or tasks that are different from the first plan.

In embodiments, the system may collect a second set of performance data that is generated when completing the activity using the second plan. Using this data, the system may update the corpus of data with the second set of performance data. The system will analyze, using the automation model, the updated corpus of data to identify a second aspect for improving efficiency of the second plan. Once identified, the system may recommend, using the automation model and based on the analyzing, modification of the second plan. The system may then continually implement changes to further plans in order to learn more about the workers assigned to different tasks.

In this way, the system utilizes two AI models to intelligently assign a diverse set of workers to activities. The activity assignment model assigns different activities to different types of human/robotic workers in an intelligent manner, so that an automation model can capture enough data from the varied types of workers during the learning process to continuously learn what workers are best at performing given activities.

In some embodiments, the system can further be extended to optimize the efficiency of processes by allocating resources appropriately without compromising the quality. For example, the system may be extended to classify the activities based on skills and timeframe and use this data to predict what can be done by human worker vs a robot worker or a combination thereof. Further, the system may be configured to identify effectiveness level of different types of workers to learn and continuously build the knowledge corpus.

The aforementioned advantages are example advantages, and not all advantages are discussed. Furthermore, embodiments of the present disclosure can exist that contain all, some, or none of the aforementioned advantages while remaining within the spirit and scope of the present disclosure.

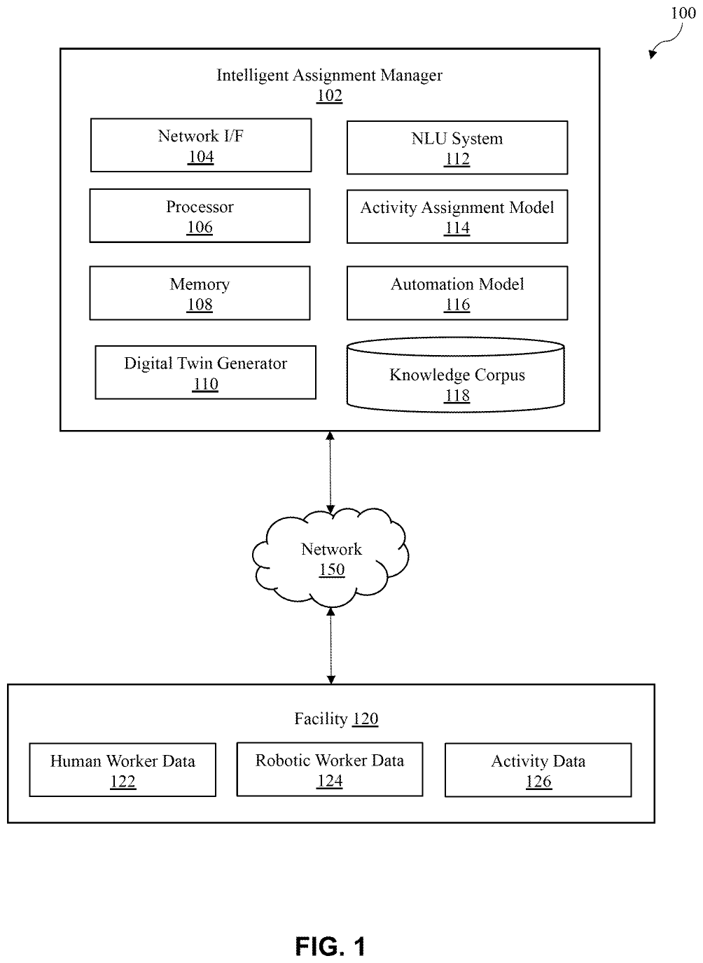

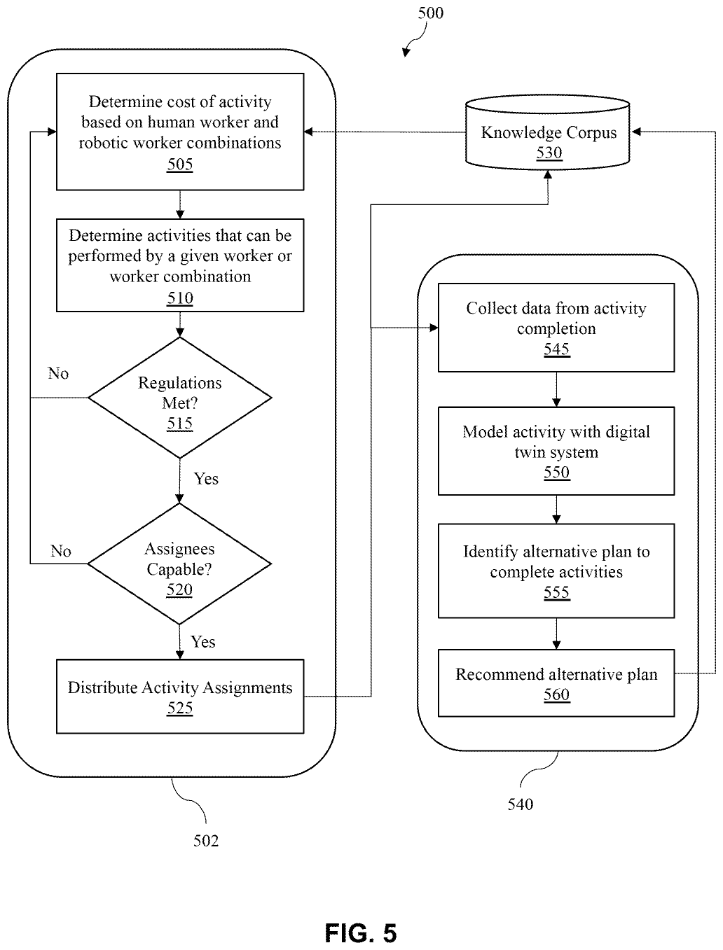

With reference now to FIG. 1, shown is a block diagram of an example intelligent assignment system 100 in which illustrative embodiments of the present disclosure may be implemented. In the illustrated embodiment, the intelligent assignment system 100 includes intelligent assignment manager 102 that is communicatively coupled to facility 120 via network 150. Facility 120 may be configured as a computing system or network maintained at a facility and is not meant to be limiting. For example, facility 120 may be a computer network maintained at any type of environment comprising of human and robotic workers (e.g., healthcare, automotive, computing, industrial, electrical engineering, and the like). In embodiments, intelligent assignment manager 102 and facility 120 may be configured as any type of computer system and may be substantially similar to computer system 501 of FIG. 5. In some embodiments, intelligent assignment manager 102 may be locally operated on facility 120.

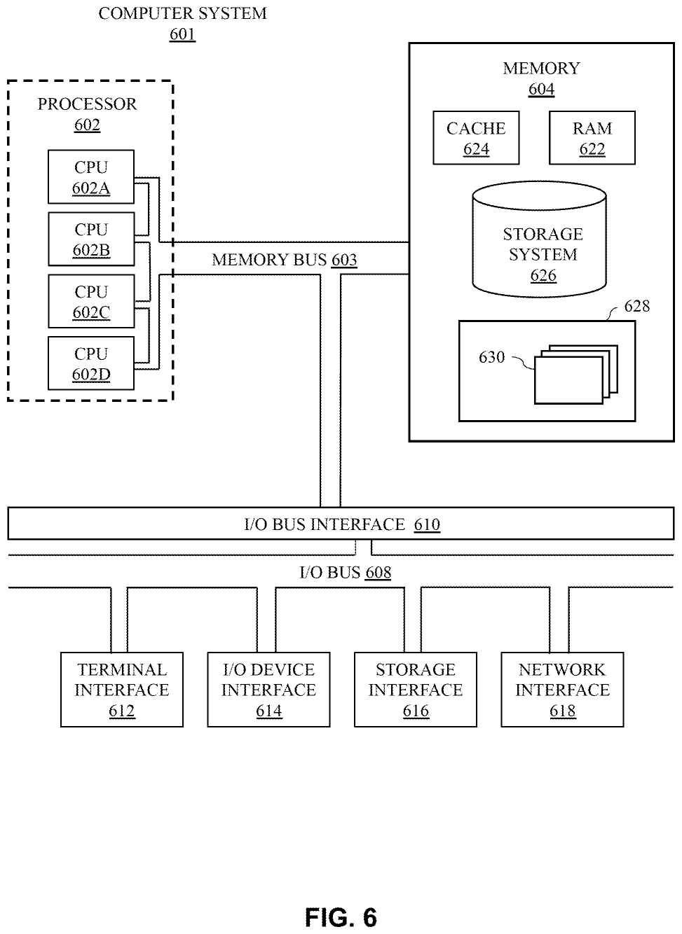

In embodiments, network 150 may be any type of communication network, such as a wireless network, edge computing network, a cloud computing network, or any combination thereof (e.g., hybrid cloud network/environment). Network 150 may be substantially similar to, or the same as, cloud computing environment 50 described in FIG. 6. Consistent with various embodiments, a cloud computing environment may include a network-based, distributed data processing system that provides one or more edge/network/cloud computing services. Further, a cloud computing environment may include many computers (e.g., hundreds or thousands of computers or more) disposed within one or more data centers and configured to share resources over network 150.

In some embodiments, network 150 can be implemented using any number of any suitable communications media. For example, the network may be a wide area network (WAN), a local area network (LAN), an internet, or an intranet. In certain embodiments, the various systems may be local to each other, and communicate via any appropriate local communication medium. For example, intelligent assignment manager 102 may communicate with facility 120 using a WAN, one or more hardwire connections (e.g., an Ethernet cable), and/or wireless communication networks. In some embodiments, the various systems may be communicatively coupled using a combination of one or more networks and/or one or more local connections.

In embodiments, intelligent assignment manager 102 includes processor 106 and memory 108. The intelligent assignment manager 102 may be configured to communicate with facility 120 through an internal or external network interface 104. The network interface 104 may be, e.g., a modem or a network interface card. The intelligent assignment manager 102 may be equipped with a display or monitor. Additionally, the intelligent assignment manager 102 may include optional input devices (e.g., a keyboard, mouse, scanner, or other input device), and/or any commercially available or custom software (e.g., browser software, communications software, server software, natural language processing/understanding software, search engine and/or web crawling software, filter modules for filtering content based upon predefined parameters, etc.).

In some embodiments, the intelligent assignment manager 102 may include digital twin generator 110, natural language understanding (NLU) system 112, activity assignment model 114, automation model 116, and knowledge corpus 118. The NLU system 112 may include a natural language processor. The natural language processor may include numerous subcomponents, such as a tokenizer, a part-of-speech (POS) tagger, a semantic relationship identifier, and a syntactic relationship identifier.

In embodiments, the digital twin generator 110 is configured generate a digital twin of facility 120 by analyzing human worker data 122, robotic worker data 124, and/or activity data 126. This data may be collected from various systems, sensors, components, workloads, IoT devices, logs, etc., that are generated by facility 120. The digital twin generator 110 may generate a digital twin of facility 120 that may be used by activity assignment model 114 or automation model 116 to make determinations on worker assignments and/or improvements to performance of activities at facility 120. The digital twin of facility 120 may also be used to identify various health of the systems maintained at the facility (electrical engineering robotic systems) and/or various control parameters of the robotic systems used for performing activities.

In embodiments, activity assignment model 114 is configured to assign different types/sets of workers to perform a given activity at facility 120. The activity assignment model 114 may assign activities based on worker capabilities, skills, health, performance, etc. The activity assignment model 114 may utilize human worker data 122, robotic worker data 124, and activity data 126 from facility 120 when making assignment decisions. Further, the activity assignment model 114 may utilize knowledge corpus 118 when making assignment decisions. The activity assignment model 114 may analyze contextual data/situational data, working environment, criticality of the activity when assigning activities to a worker, which may be obtain from facility 120. In embodiments, the activity assignment model 114 may utilize NLU system 112 to analyze unstructured data related to various data types. For example, the NLU system 112 may analyze skills related to given workers from user profiles or resume data on file at the facility. In another example, the NLU system 112 may analyze manuals or documentation associated with robotic systems used at the facility to identify their capabilities for performing activities.

In embodiments, automation model 116 is configured to analyze performance data generated from workers completing various activities and use this data to make determinations on how to improve worker assignments for completing activities at the facility. In embodiments, the automation model 116 may make recommendations on how to perform the activities in a more efficient way. This may include recommending using different workers (human, robotic, or a combination of both) and/or changing how the activity is performed. The automation model 116 may update the knowledge corpus 118 with performance data as the activities are completed and generate recommendations based on analyzing the data distribution associated with worker performance of activities.

In some embodiments, activity assignment model 114 and automation model 116 may use machine learning algorithms to improve their capabilities automatically through experience and/or repetition without procedural programming. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBDT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

It is noted that FIG. 1 is intended to depict the representative major components of an exemplary intelligent assignment system 100. In some embodiments, however, individual components may have greater or lesser complexity than as represented in FIG. 1, components other than or in addition to those shown in FIG. 1 may be present, and the number, type, and configuration of such components may vary.

For example, while FIG. 1 illustrates an intelligent assignment system 100 with a single intelligent assignment manager 102, a single facility 120, and a single network 150, suitable computing environments for implementing embodiments of this disclosure may include any number of intelligent assignment systems, intelligent assignment managers, facilities, and networks. The various modules, systems, and components illustrated in FIG. 1 may exist, if at all, across a plurality of intelligent assignment systems, intelligent assignment managers, facilities, and networks.

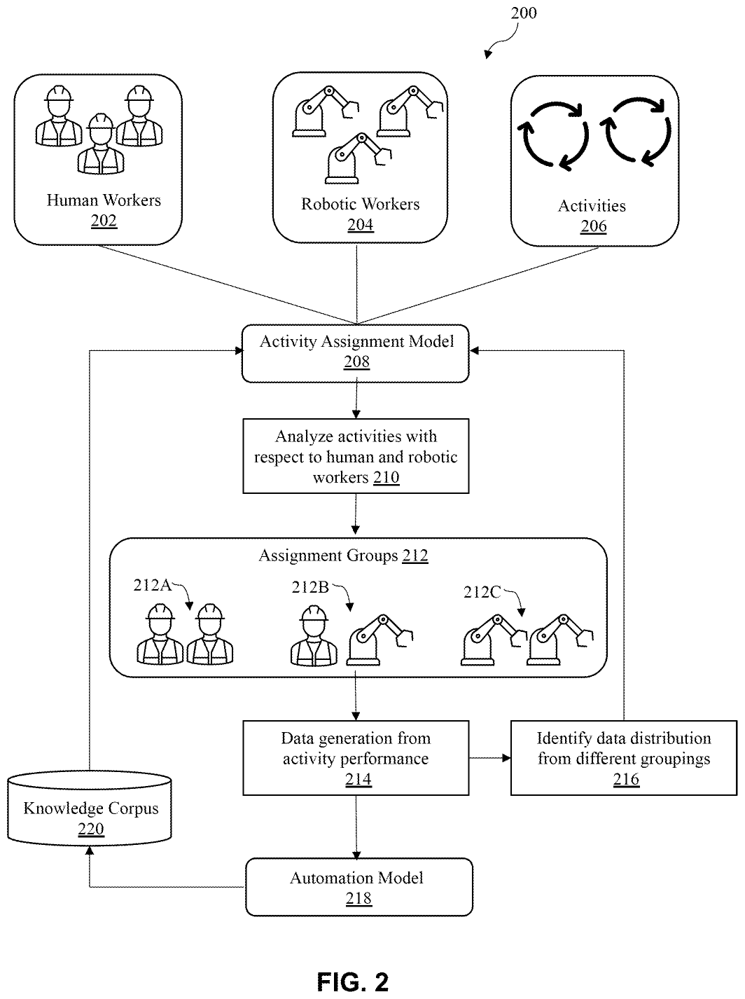

Referring now to FIG. 2, shown is an example diagram 200 for intelligent assignment of activities, in accordance with some embodiments of the present disclosure. In the illustrated embodiment, the activity assignment model 208 collects human worker data 202, robotic worker 204, and activity data 206 in order to intelligently assign activities to be completed at a facility. This data may also be collected from knowledge corpus 220. Once collected, activity assignment model 208 analyzes activities that are to be performed at the facility with respect to the available workers. This is shown at box 210. The activity assignment model 208 may identify differences in the human workers (e.g., skillset, capabilities, work restrictions, persona, etc.) and robotic workers (e.g., type of robotic worker, health condition, etc.) and assign them to perform the activities. The activity assignment model 208 will also be considering the contextual situation, working environment, criticality of the activities, etc., and assign the activities accordingly. The activity assignment model 208 may assign the workers to perform an activity according to various assignment groups 212. For example, assignment group 212A comprises human workers only, assignment group 212C comprises robotic workers only, and assignment group 212B is made up of a combination of human and robotic workers. Each assignment group 212 assigned to perform an activity may be determine based on a confidence score that indicates how efficiently a group would be able to complete the activity. For example, a high confidence score would indicate the group would efficiently complete the activity, while a low confidence score would indicate the group would inefficiently complete the activity.

In embodiments, each of the assignment groups 212 performs their activity and generates performance data. This is shown in box 214. This data may be generated/collected from various sensors, IoT devices, scans, logs, systems, robotic systems, etc., associated with the facility. The generated data is then collected by an automation model 218, which analyzes the data to identify aspects of the performance of activities that can be improved. This may include recommending using alternative workers to perform the activities or changing how the activities are done based on worker capabilities. The automation model 218 may update knowledge corpus 220 with the recommendation/adjustment to the performance of the activities.

Additionally, the generated performance data may be gathered by the activity assignment model 208 to identify data distribution from the different groupings and modify how different workers are to be assigned to perform different activities. This is shown at box 216. In this way, the activity assignment model 208 continuously assigns different workers to the activities to generate a larger amount of data (data diversity) that the system can learn from.

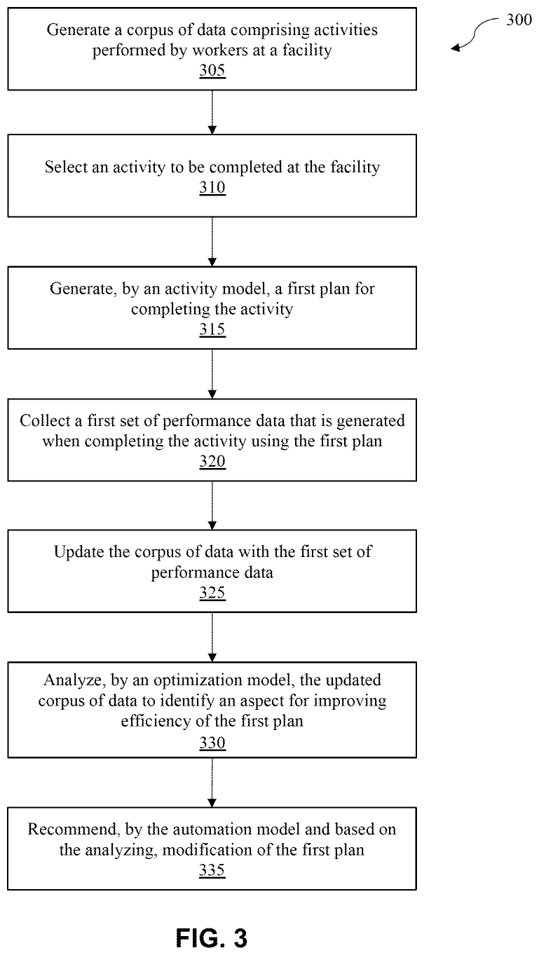

Referring now to FIG. 3, shown is an example process 300 for intelligent assignment of workers using predictive learning, in accordance with some embodiments of the present disclosure. The process 300 may be performed by processing logic that comprises hardware (e.g., circuitry, dedicated logic, programmable logic, microcode, etc.), software (e.g., instructions run on a processor), firmware, or a combination thereof. In some embodiments, the process 300 is a computer-implemented process. In embodiments, the process 300 may be performed by processor 106 of intelligent assignment manager 102 exemplified in FIG. 1.

In embodiments, the process 300 begins by generating, for a digital twin of a facility, a corpus of data, wherein the corpus of data comprises a plurality of activities performed by a plurality of workers at the facility. This is illustrated at step 305. In embodiments, the plurality of workers may comprise both human workers and robotic workers (or systems).

In embodiments, the corpus of data may be generated from various data collected from the facility. For example, the system may collect human worker data, robotic worker data, activity data, and/or tasks performed at the facility from facility computer systems. For example, the system may capture data generated from Internet of Things (IoT) devices, robotic systems, networks, sensors, log etc., associated with the facility and use those gathered data through machine learning to create knowledge corpus.

In embodiments, the corpus of data may include additional attributes associated with the facility, the activities, and the workers. For example, the attributes may include tasks associated with completing each of the plurality of activities, specialist categories associated with each workers, worker capabilities, human and robotic worker health or condition, activity types, activity volume, facility demographics, activity costs, and laws associated with performing activities at the facility.

The process 300 continues by selecting an activity to be completed at the facility. This is illustrated at step 310. The activity can be any type of activity to be performed at the facility. The activity can be a set of activities and is not limited to a single activity.

The process 300 continues by generating, by an activity assignment model and based on the corpus of data, a first plan for completing the activity. This is illustrated at step 315. The first plan may comprise a first set of tasks for completing the activity and a first set of workers to perform the first set of tasks. For example, an activity may require multiple steps or tasks to be performed by the worker(s) to complete the activity. In embodiments, the first plan may be based on analyzing worker capabilities associated with completing the first set of tasks. For example, the activity assignment model will only assign workers to complete tasks that they are capable of completing. Further, generation of the first plan for competing the activity may be based on analyzing a distribution of the corpus of data. In this way, the activity assignment model can identify based on the data distribution, which workers are best for completing which activities.

The process 300 continues by collecting a first set of performance data that is generated when completing the activity using the first plan. This is illustrated at step 320. For example, based on the assigned activity to different workers, the workers will be performing the activities and while activity is being performed, performance data will be generated and collected from various IoT devices, scanning, and/or data logs, associated with the facility.

The process 300 continues by updating the corpus of data with the first set of performance data. This is illustrated at step 325. For example, the performance data will be added to the knowledge corpus in order to determine differences from the first plan and the historical data of the corpus.

The process 300 continues by analyzing, using an automation model, the updated corpus of data to identify an aspect for improving efficiency of the first plan. This is illustrated at step 330. For example, the automation model may identify that a given worker (human or robotic) may perform a task of the first plan better or more efficiently than another worker. This may be done by comparing historic data set with the first set of performance data or current data. In embodiments, identifying the aspect for improving efficiency of the first plan may be based on analyzing the data distribution of the updated corpus of data. For example, the automation model may determine from the data distribution related to worker performance which worker is best for performing the given activity/task.

The process 300 continues by recommending, by the automation model and based on the analyzing, modification of the first plan. This is illustrated at step 335. For example, the automation model may recommend changing the first plan to include at least one alternative task and/or at least one alternative worker.

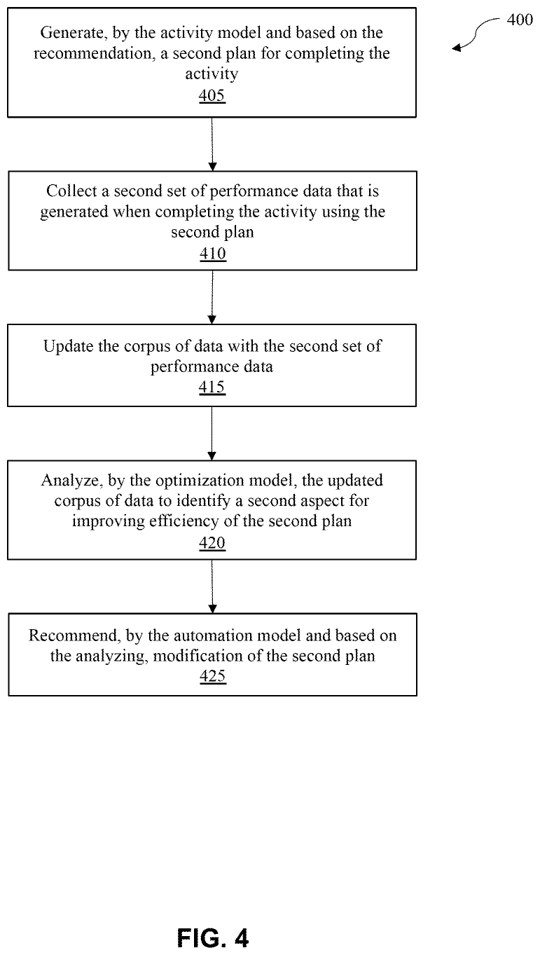

In some embodiments, the process 300 may continue to step 405 of process 400 as described in FIG. 4. Referring now to FIG. 4, shown is process 400 which may be in addition to or a subprocess of the example process 300 of FIG. 3, in accordance with some embodiments of the present disclosure. The process 400 may be performed by processing logic that comprises hardware (e.g., circuitry, dedicated logic, programmable logic, microcode, etc.), software (e.g., instructions run on a processor), firmware, or a combination thereof. In some embodiments, the process 400 is a computer-implemented process. In embodiments, the process 400 may be performed by processor 106 of intelligent assignment manager 102 exemplified in FIG. 1.

Process 400 begins by generating, using the activity assignment model and based on the recommending, a second plan for completing the activity. This is illustrated at step 405. In embodiments, the second plan may include a second set of tasks for completing the activity and a second set of workers to perform the second set of tasks, where the second set of tasks and the second set of workers are different than the first set of tasks and first set of workers of the first plan. For example, the activity assignment model will generate a new plan to perform the activity that includes the modification to the first plan. This may include using one or more different workers (different capabilities, skills, availability, etc.) to perform the activity, or modifying one of the tasks required for performing the activity. In this way, the activity assignment model continually adjust the assigned workers in a diverse manner in order to allow the system to learn which workers are best assigned to given activities.

Process 400 continues by collecting a second set of performance data that is generated when completing the activity using the second plan. This is illustrated at step 410. Process 400 continues by updating the corpus of data with the second set of performance data. This is illustrated at step 415.

Process 400 continues by analyzing, using the automation model, the updated corpus of data to identify a second aspect for improving efficiency of the second plan. This is illustrated at step 420. For example, the automation model will analyze the second set of performance data with respect the corpus of data to determine if additional improvements can be made to the second plan. It may be that the modified plan did not improve efficiency when completing the activity. Therefore, the automation model may identify other areas for improvement of the second plan (changes to work type, worker capabilities, etc.).

Process 400 continues by recommending, using the automation model and based on the analyzing, modification of the second plan. This is illustrated at step 425. In embodiments, the system will continuously attempt to improve worker assignment to obtain the most efficient performance of activities at the facility. In this way, the system will continuously learn which modifications result in better outcomes for completing activities at the facility.

Referring now to FIG. 5, shown is an example process 500 for intelligent assignment of activities based on various attributes, in accordance with some embodiments of the present disclosure. In the illustrated embodiment, activity assignment model 502 and automation model 540 each perform different steps of process 500.

Process 500 begins by determining the cost of activity based on the human worker and robotic worker combination. This is illustrated at step 505. For example, the activity assignment model 502 may take into account how much each given worker costs (financial, time, and/or depreciation costs) to be used to complete a given activity. This data may be obtained from knowledge corpus 530. Knowledge corpus 530 may comprise attributes such as costs of activities, activity types, robotic worker capabilities, human worker capabilities, laws, programming, data logs, IoT data, etc.

Process 500 continues by determining which activities can be performed by a given worker or worker combination. This is illustrated at step 510. For example, the system will identify which activities that are performed at the facility can be performed by a given worker. This may be based on a range of capabilities. For example, some workers (robotic/human) may perform activities better than others, but all workers may be sufficiently capable of completing the activity even if it's in an inefficient manner.

Process 500 continues by determining if worker regulations are met. This is illustrated at step 515. For example, the activity assignment model 502 will determine if the assignments to perform activities conform to legal regulations for human workers. If “No” at step 515, then the process 500 will return to step 505 and reassign a different worker for the activity. If “Yes” at step 515, the process 500 continues to step 520 and determines if all assigned workers are capable of performing the activity. This may be based on a confidence threshold. For example, the system may identify a minimum requirement (score) of capabilities for performing the activity. If the confidence threshold is not met, “No” at step 520, then the process 500 returns to step 505 for reassignment of workers. If “Yes” at step 520, then the process 500 continues to distribute activity assignments. This is illustrated at step 525. The activity assignment model 502 will distribute the assignments at which point the workers will begin performing their given assigned activity. The assignment data may also be added to knowledge corpus 530.

Process 500 continues by collecting performance data from activity completion. This is illustrated at step 545. For example, the automation model 540 will gather data from various systems, sensors, logs, etc., from the facility as the workers are completing their activities.

Process 500 continues by modeling the activity with a digital twin system. This is illustrated at step 550. Using the digital twin allows the automation model 540 to learn how the activities are being performed by the workers and where improvements can be made to the processes for completing the activities.

Process 500 continues by identifying an alternative plan to complete activities. This is illustrated at step 555. Using the digital twin, the automation model 540 can pinpoint areas of improvement and determine an alternative plan for completing the activity.

Process 500 continues by recommending the alternative plan. This is illustrated at 560. The automation model 540 will recommend an alternative plan that may include changing worker types or altering how various tasks are performed when completing the activity. The recommendation may be added to the knowledge corpus 530. This may be used by the activity assignment model 502 when assigning workers to activities. In this way, the automation model 540 works in conjunction with the activity assignment model 502 to continuously modify and adjust worker assignments for performing activities in order to learn which assignments result in the most efficient performance.

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/0 bus 608, and an I/O bus interface 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache. In some embodiments, a processor can include at least one or more of, a memory controller, and/or storage controller. In some embodiments, the CPU can execute the processes included herein (e.g., process 300 and 400 as described in FIG. 3 and FIG. 4, respectively). In some embodiments, the computer system 601 may be configured as intelligent assignment system 100 of FIG. 1.

System memory subsystem 604 may include computer system readable media in the form of volatile memory, such as random-access memory (RAM) 622 or cache memory 624. Computer system 601 may further include other removable/non-removable, volatile/non-volatile computer system data storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 604 can include flash memory, e.g., a flash memory stick drive or a flash drive. Memory devices can be connected to memory bus 603 by one or more data media interfaces. The memory subsystem 604 may include at least one program product having a set (e.g., at least one) of program modules that are configured to carry out the functions of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single units, the computer system 601 may, in some embodiments, contain multiple I/O bus interfaces 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

One or more programs/utilities 628, each having at least one set of program modules 630 may be stored in memory subsystem 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 628 and/or program modules 630 generally perform the functions or methodologies of various embodiments.

It is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various search servers through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

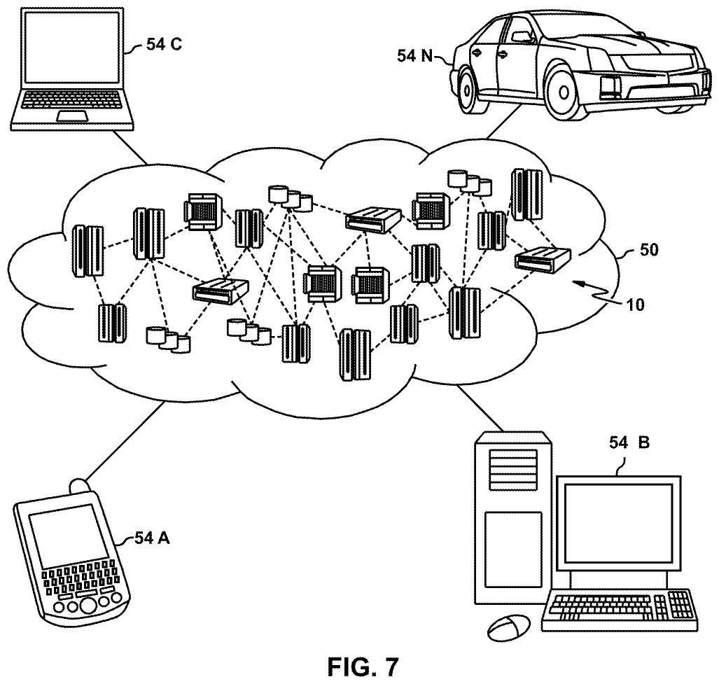

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

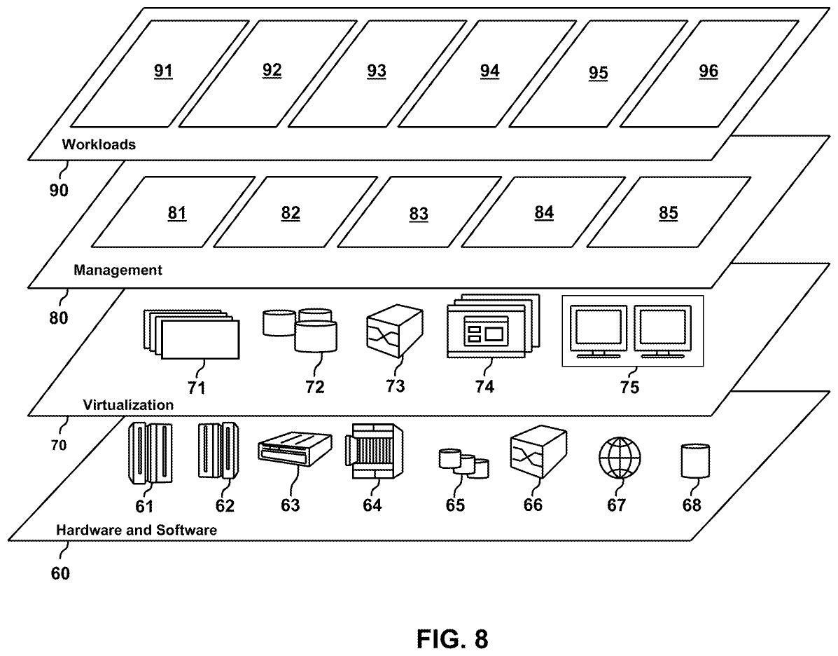

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and container orchestration management software 68 in relation to the intelligent assignment system 100 of FIG. 1.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and intelligent assignment management processing 96. For example, intelligent assignment system 100 of FIG. 1 may be configured to manage activity assignment and digital twin generation using workloads layer 90.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer-implemented method comprising:
generating, for a digital twin of a facility, a corpus of data, wherein the corpus of data comprises a plurality of activities performed by a plurality of workers at the facility;
selecting an activity to be completed at the facility;
generating, by an activity assignment model and based on the corpus of data, a first plan for completing the activity, the first plan comprising a first set of tasks for completing the activity and a first set of workers to perform the first set of tasks;
collecting a first set of performance data that is generated when completing the activity using the first plan;
updating the corpus of data with the first set of performance data;
analyzing, by an automation model, the updated corpus of data to identify an aspect for improving efficiency of the first plan; and
recommending, by the automation model and based on the analyzing, modification of the first plan.

2. The computer-implemented method of claim 1, further comprising:
generating, by the activity assignment model and based on the recommending, a second plan for completing the activity;
collecting a second set of performance data that is generated when completing the activity using the second plan;
updating the corpus of data with the second set of performance data;
analyzing, by the automation model, the updated corpus of data to identify a second aspect for improving efficiency of the second plan; and
recommending, by the automation model and based on the analyzing, modification of the second plan.

3. The computer-implemented method of claim 2, wherein the second plan comprises a second set of tasks for completing the activity and a second set of workers to perform the second set of tasks, wherein the second set of tasks and the second set of workers are different than the first set of tasks and first set of workers of the first plan.

4. The computer-implemented method of claim 1, wherein recommending the modification of the first plan comprises changing the first plan to include at least one alternative task and/or at least one alternative worker.

5. The computer-implemented method of claim 1, wherein the plurality of workers comprise both human workers and robotic workers.

6. The computer-implemented method of claim 1, wherein the corpus of data further includes data attributes associated with the facility, the plurality of activities, the plurality of workers, the data attributes selected from a group of attributes consisting of:
tasks associated with the plurality of activities;
specialist categories associated with each of the plurality of workers;
worker capabilities;
worker health;
activity types;
activity volume;
facility demographics;
activity costs; and
laws associated with activities.

7. The computer-implemented method of claim 1, wherein the first plan is further based on analyzing worker capabilities associated with completing the first set of tasks.

8. The computer-implemented method of claim 1, wherein generating the first plan for competing the activity is based on analyzing a distribution of the corpus of data.

9. The computer-implemented method of claim 1, wherein analyzing the updated corpus of data to identify the aspect for improving efficiency of the first plan is based on a data distribution of the updated corpus of data.

10. A system comprising:
a processor; and
a computer-readable storage medium communicatively coupled to the processor and storing program instructions which, when executed by the processor, cause the processor to perform a method comprising:
generating, for a digital twin of a facility, a corpus of data, wherein the corpus of data comprises a plurality of activities performed by a plurality of workers at the facility;
selecting an activity to be completed at the facility;
generating, by an activity assignment model and based on the corpus of data, a first plan for completing the activity, the first plan comprising a first set of tasks for completing the activity and a first set of workers to perform the first set of tasks;
collecting a first set of performance data that is generated when completing the activity using the first plan;
updating the corpus of data with the first set of performance data;
analyzing, by an automation model, the updated corpus of data to identify an aspect for improving efficiency of the first plan; and
recommending, by the automation model and based on the analyzing, modification of the first plan.

11. The system of claim 10, wherein the method performed by the processor further comprises:
generating, by the activity assignment model and based on the recommending, a second plan for completing the activity;
collecting a second set of performance data that is generated when completing the activity using the second plan;
updating the corpus of data with the second set of performance data;
analyzing, by the automation model, the updated corpus of data to identify a second aspect for improving efficiency of the second plan; and
recommending, by the automation model and based on the analyzing, modification of the second plan.

12. The system of claim 11, wherein the second plan comprises a second set of tasks for completing the activity and a second set of workers to perform the second set of tasks, wherein the second set of tasks and the second set of workers are different than the first set of tasks and first set of workers of the first plan.

13. The system of claim 10, wherein recommending the modification of the first plan comprises changing the first plan to include at least one alternative task and/or at least one alternative worker.

14. The system of claim 10, wherein the plurality of workers comprise both human workers and robotic workers.

15. The system of claim 10, wherein the first plan is further based on analyzing worker capabilities associated with completing the first set of tasks.

16. A computer program product comprising a computer-readable storage medium having program instructions embodied therewith, the program instructions executable by a processor to cause the processor to perform a method comprising:
generating, for a digital twin of a facility, a corpus of data, wherein the corpus of data comprises a plurality of activities performed by a plurality of workers at the facility;
selecting an activity to be completed at the facility;
generating, by an activity assignment model and based on the corpus of data, a first plan for completing the activity, the first plan comprising a first set of tasks for completing the activity and a first set of workers to perform the first set of tasks;
collecting a first set of performance data that is generated when completing the activity using the first plan;
updating the corpus of data with the first set of performance data;
analyzing, by an automation model, the updated corpus of data to identify an aspect for improving efficiency of the first plan; and
recommending, by the automation model and based on the analyzing, modification of the first plan.

17. The computer program product of claim 16, wherein the method performed by the processor further comprises:
generating, by the activity assignment model and based on the recommending, a second plan for completing the activity;
collecting a second set of performance data that is generated when completing the activity using the second plan;
updating the corpus of data with the second set of performance data;
analyzing, by the automation model, the updated corpus of data to identify a second aspect for improving efficiency of the second plan; and
recommending, by the automation model and based on the analyzing, modification of the second plan.

18. The computer program product of claim 17, wherein the second plan comprises a second set of tasks for completing the activity and a second set of workers to perform the second set of tasks, wherein the second set of tasks and the second set of workers are different than the first set of tasks and first set of workers of the first plan.

19. The computer program product of claim 16, wherein recommending the modification of the first plan comprises changing the first plan to include at least one alternative task and/or at least one alternative worker.

20. The computer program product of claim 16, wherein the plurality of workers comprise both human workers and robotic workers.
